(19) United States
(12) Patent Application Publication
(10) Pub. No.: US 2026/0021009 A1
(43) Pub. Date: Jan. 22, 2026

(54) MULTI-TILED PLENOPTIC SYSTEM FOR MULTIPLE VISION TREATMENTS AND TRAINING FOR THE INDUCTION OF HYPER VISUAL ACUITY

(71) Applicant: Soliddd Corp., New York, NY (US)

(72) Inventor: Neal Weinstock, New York, NY (US)

(21) Appl. No.: 19/275,446

(22) Filed: Jul. 21, 2025

Related U.S. Application Data
(60) Provisional application No. 63/674,027, filed on Jul. 22, 2024.

(51) Int. Cl. A61H 5/00

(52) U.S. Cl. CPC A61H 5/00

(57) ABSTRACT

One embodiment provides a system and method that assist in curing or providing relief for ocular conditions utilizing a visual aid device that presents images to one or more areas of interest on the eye of the user. Additionally, utilizing the described visual aid device, the system and method can induce hyperacuity in a user also through the presentation of images. Different characteristics of the images that are generated and presented may be modified based upon the desired application. Other embodiments are described herein.

### CROSS-REFERENCE TO RELATED APPLICATIONS

This application is a non-provisional conversion of U.S. Provisional Application Ser. No. 63/674,027, filed Jul. 22, 2024, the contents of which are incorporated by reference herein.

### FIELD OF THE INVENTION

The present disclosure generally relates to a visual aid device, more particularly, to a visual aid device that can provide several kids of treatments for vision problems, and training for the induction of hyper visual acuity.

### BACKGROUND OF THE INVENTION

Many people have eye and/or brain conditions that may result in reduced viewing ability (glaucoma, myopia, etc.), with properly seeing text (e.g., dyslexia, etc.), and/or the like. Additionally, some people are able to see objects with super-normal visual acuity, or “hyperacuity,” which may be considered so highly beneficial that the majority of people who lack the ability may be considered vision impaired compared to those who have strong hyper visual acuity. While visual aid devices, for example, eyeglasses, typical contacts lenses, low-vision aids, and/or the like, may assist or correct for some ocular conditions, many other conditions are either untreatable or uncurable, and current training techniques to induce hyper visual acuity are minimally effective.

### SUMMARY OF THE INVENTION

Many kinds of visual aid devices are helpful for correcting or enhancing a user's vision, including demagnification lenses for nearsightedness, magnification lenses for farsightedness, and more complex recent developments including Fresnel prism glasses for diplopia, Fresnel ring contact lenses as a more advanced treatment than simple demagnification for myopia, and low-vision augmented or virtual reality glasses that may help some users more serious vision impairments. However, visual aid devices are not available for correcting all defects in users' sight. For example, visual aid devices to address ocular diseases including macular degeneration, glaucoma, and/or the like, generally either do not exist, or at best, for these conditions, may utilize a display that allows the person to adjust video to add contrast, change color, add what is commonly known as “picture-in-picture” to show a redundant section of the overall image in an additional area, add brightness, provide text-to-speech for written information recognized in video, and/or the like.

These techniques may be helpful, but are limited in effectiveness. Text to speech does nothing to help vision. Current contrast, brightness and color adjustment rely on the user viewing the world entirely on video (rather than directly, through a passive lens such as in normal eyeglasses) and perform these adjustments on the entire video image at once, regardless of where in the eye the damage needs correction. Picture-in-picture may be a help to some but not to most users, according to a number of studies, depending on where in the eye and what type of problems the user suffers from. Current visual aid devices are also not able to cure or provide relief for certain other vision problems. For example, while visual aid devices exist to correct for myopia, these visual aid devices merely correct a viewing field of the user while the visual aid device is worn, but do not assist in curing myopia. As another example, few visual aids have targeted correction for dyslexia, and none successfully. The only treatments with any success at all for dyslexia have been many-years-long educational therapies.

Hyper visual acuity, or hyperacuity, is something that allows a user to visually perceive fine details while maintaining a full normal visual field (as opposed to the greater detail seen when using a magnifying lens), and even during high-speed movements. While hyperacuity is known and has been found to be beneficial in such activities as aiming a precision instrument or hitting a baseball, there have been no visual aid devices that allow for the induction of hyperacuity. The described system would allow for the induction of hyperacuity, including in those people who are not now naturally capable of hyperacuity.

One embodiment provides a system and method that assist in curing or providing relief for vision problems utilizing a visual aid device that presents images to one or more areas of interest in the eye of the user. Additionally, utilizing the described visual aid device, the system and method can induce hyperacuity in a user also through the presentation of multiple images. Different characteristics of the images that are generated and presented may be modified based upon the desired application.

### A BRIEF DESCRIPTION OF THE DRA WINGS

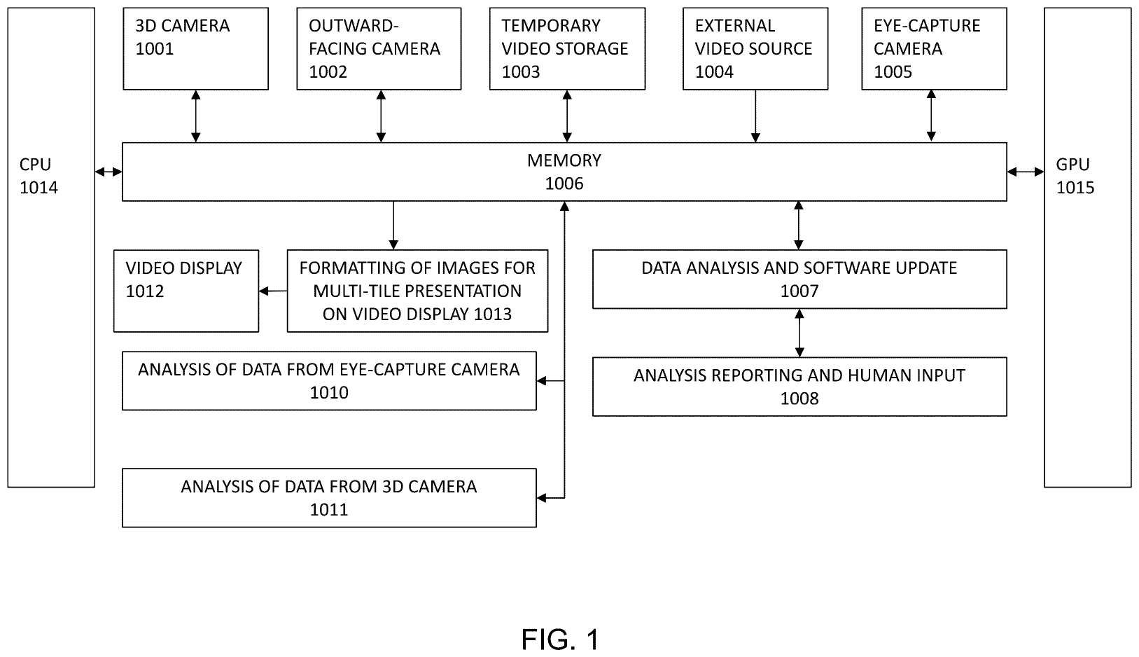

FIG. 1 illustrates a block diagram showing an example apparatus device.

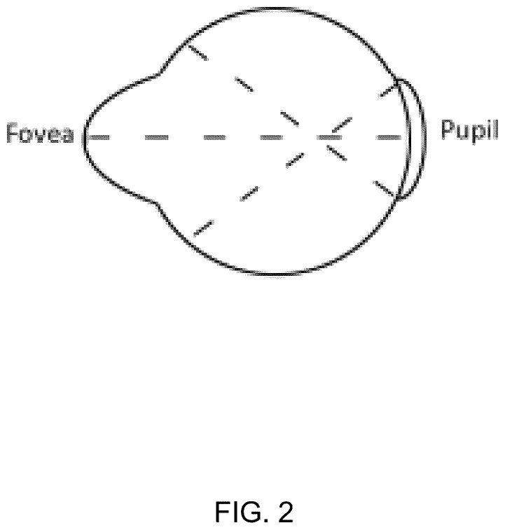

FIG. 2 illustrates an example of a typical myopic eye showing elongation and different focal lengths for light entering the pupil from different directions.

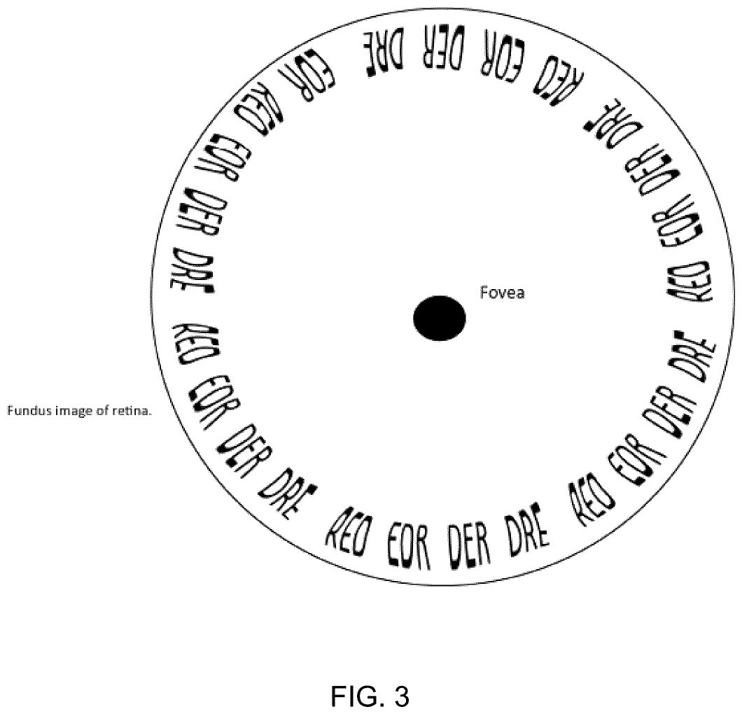

FIG. 3 illustrates an example of projected structured light images using high brightness red light.

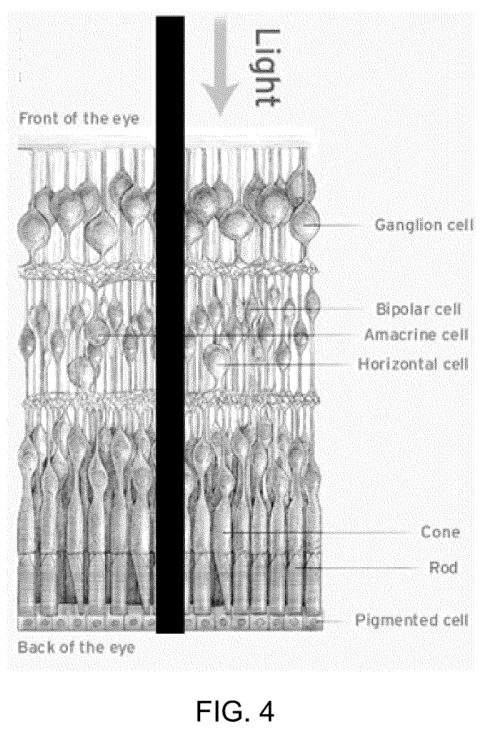

FIG. 4 illustrates an example for shutting off light to a given ganglion.

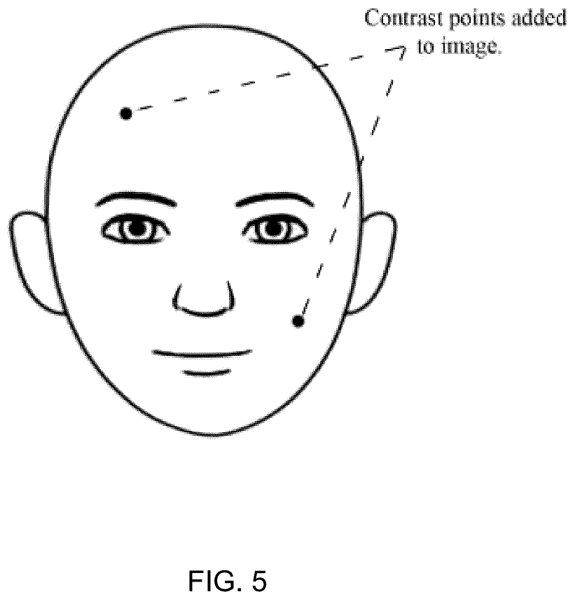

FIG. 5 illustrates an example image with added points of contrast.

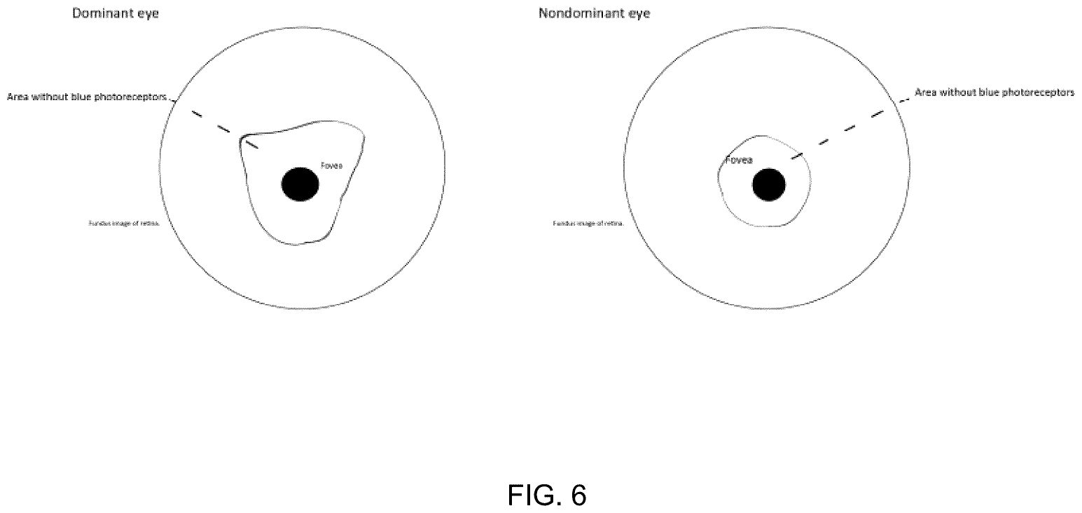

FIG. 6 illustrates typical areas with no blue photoreceptors in dominant vs. nondominant eyes.

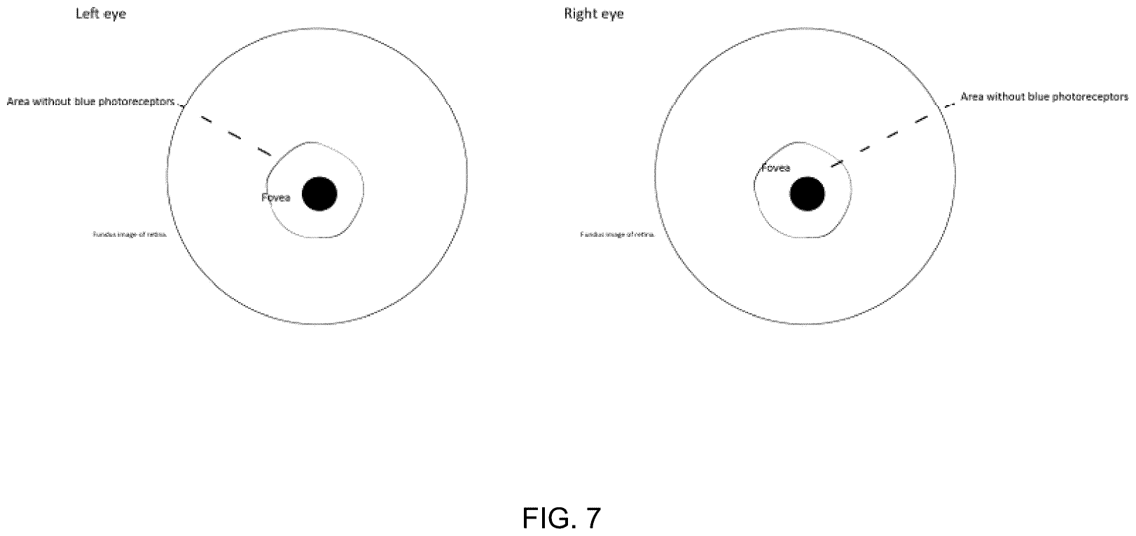

FIG. 7 illustrates typical areas without blue photoreceptors for people with dyslexia.

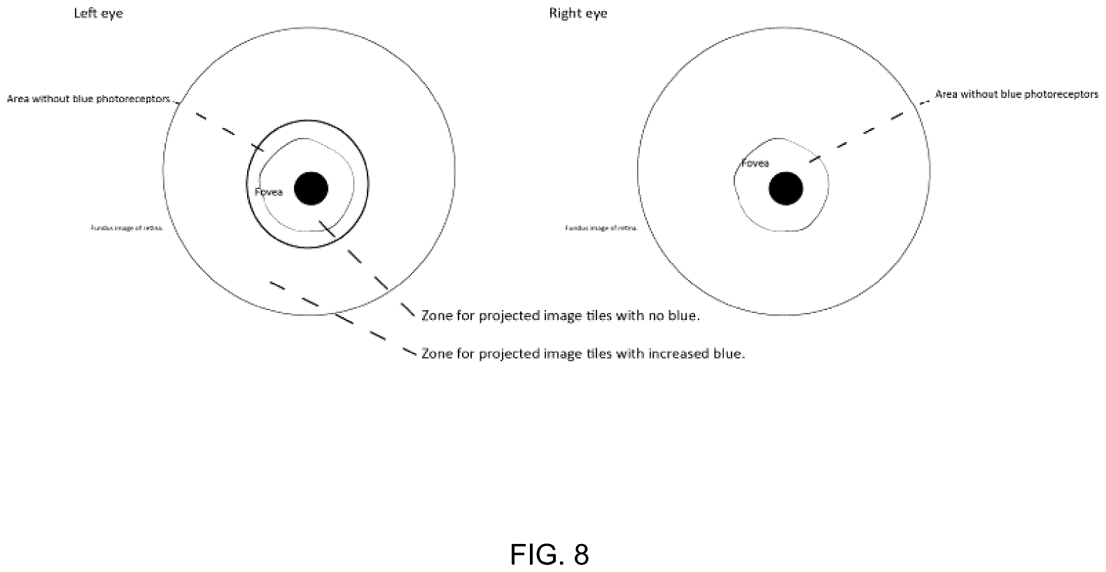

FIG. 8 illustrates the changed distribution of blue light in one eye to create eye dominance.

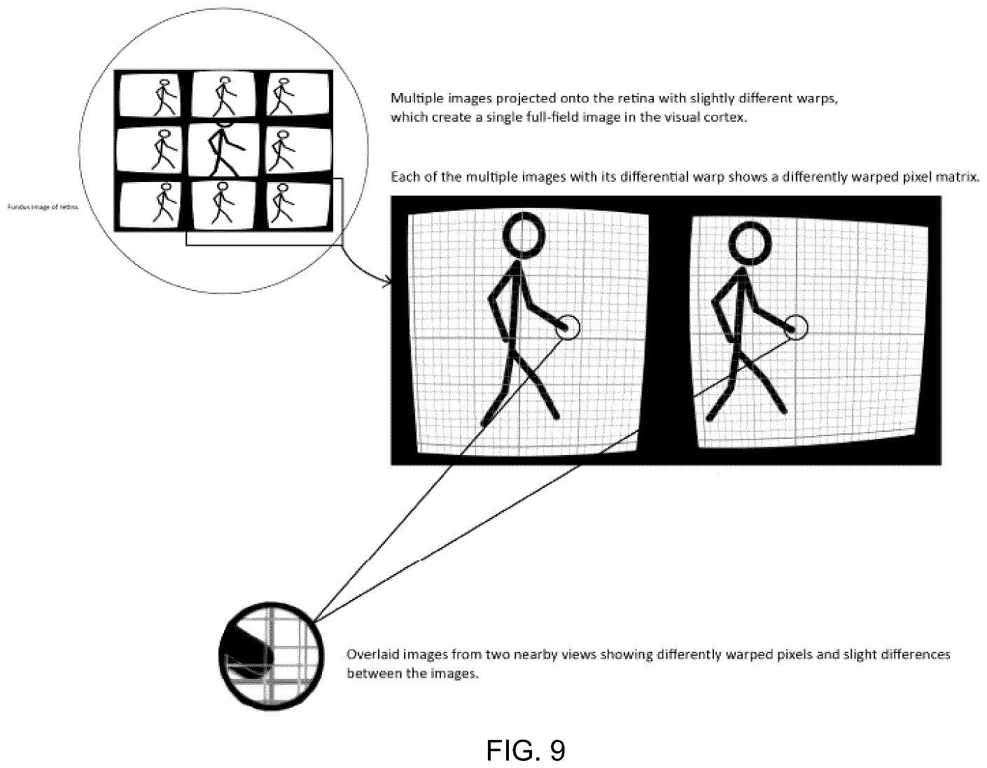

FIG. 9 illustrates warped image tiles for use in hyper visual acuity.

### DETAILED DESCRIPTION OF THE INVENTION

The described system and method provide a technique to generate and present a plurality of images of the interior of the eye, to use those images to assist in correcting, curing, and/or providing relief for various vision problems and/or ocular conditions, and induce hyperacuity, even in those individuals who are not naturally capable of hyperacuity. The described system and method utilizes a visual aid device which can display images and present those images to a user of the device. The images that are presented are generated in view of an application of the visual aid device. In other words, the images that are generated are generated in view of the particular vision or ocular issue or desired result that the visual aid device is being used to treat, cure, or induce.

In some applications, for example, treatment and cure of myopia, treatment of macular degeneration, the diagnostics of particular diseases, and/or the like, the solution is the presentation of images having a particular color and brightness at particular areas of interest of the eye or eyes of the user. The color and brightness provided within the images can mimic treatments that have been found to be useful, such as the use of lasers or bright lights. However, since the visual aid devices can be worn all the time if desired/needed, the frequency of treatment can be more often than possible using conventional treatments. Additionally, exposure to bright lights and lasers, as used in conventional treatments, has to be limited so as to not damage the eye. The visual aid device as discussed herein can be utilized to pinpoint the treatment, as with a laser in an office setting, thereby reducing the likelihood of damage to other portions of the eye.

In other applications, for example, visual correction for glaucoma, visual correction for macular degeneration, and/or the like, images may be utilized having added points of contrasting interest. Specifically, to the images, the system can add points of information, rather than simply adding contrast. In still other applications, for example, the treatment or relief of dyslexia, a lack of normal eye dominance has been shown to have a strong correlation with the relative presence of blue photo receptors and with dyslexia. It has been shown that eye dominance can be trained at young ages. However, even in older users or those whose eye dominance cannot be retrained, the described visual aid device can be utilized to assist in the relief of dyslexia, even if eye dominance cannot be retrained. In such an application, modification of blue information within images can be performed. Additionally, video frame rate can be varied per eye or different information can be provided to each eye, which can assist in the cure or relief of dyslexia, but can have other obvious uses.

Finally, in an application to induce hyper visual acuity, the system can be utilized to train individuals to make use of greater levels of hyperacuity. The system can generate images that have increasingly subtle differences between lines, dots, or other images. Repeated exposure to increasingly small offsets in graphics has been proven effective at training hyperacuity, and the system is uniquely capable of accomplishing this training in the most efficient manner.

The coordinated image display device, also referred to as a visual aid device, may make use of a plenoptic lens array, for example, like those described in commonly owned U.S. patent application Ser. No. 16/436,343, filed Jun. 10, 2019, and titled “NEAR-EYE FOVEAL DISPLAY”, which is a continuation-in-part of U.S. patent application Ser. No. 15/671,694, filed Aug. 8, 2017, and titled “NEAR-EYE FOVEAL DISPLAY”, which is a continuation-in-part of U.S. patent application Ser. No. 15/594,029, filed May 12, 2017, and titled “NEAR-EYE FOVEAL DISPLAY”, the contents of which are incorporated by reference herein. The visual aid device may also utilize the software techniques disclosed in commonly-owned U.S. patent application Ser. No. 17/554,779, which is also incorporated by reference herein. Other lens arrays may be utilized, for example, a lens array within a liquid crystal cell, a metalens, laser scan display, and/or any optical technique that can be used to project multiple simultaneous parallel ray images. Images of the eye may also be captured, for example, using a plenoptic lens array. From the images, the position and geometry of the internal areas of the eye, including the full surface of the retina, fovea, cornea, macula, and/or the like, may be identified. Additionally, by using nonvisual wavelengths of light, the images can see more or less deeply into surrounding tissues, bones, blood vessels, nerves, and/or the like.

From the captured image(s) the system can identify a plurality of characteristics of the eye. The characteristics may include a position of a pupil of the eye, characteristics that are indicative of an eye disease and a location of the eye disease within the eye, characteristics that are indicative of an ocular condition, and/or the like. With the characteristics, the assistive viewing system can also identify the location of different phenomena across the eye. For example, macular degeneration or retinitis may only affect parts of the eye. As another example, glaucoma may be characterized by a reduced viewing field. Thus, not all the eye may be affected.

The captured images of multiple portions of the eye are made possible by synchronized lighting, from the display, of only those same multiple portions of the eye, while leaving all other areas of the eye unlit. In current examination and captured photographs of the eye, it is necessary to illuminate most or all of the visual field, and often under conditions of extreme dilation of the pupil which lasts for a substantial period of time even after examination is finished or photos have been taken. This is inconvenient for the patient and also does not allow for continual monitoring of the eye while the patient goes about normal activities. The current invention, making use of the above-noted plenoptic lens array, is able to time illumination of an area of the eye as small as a single pixel imaged in a tiny area of the retina with photography of that same area. Furthermore, when the photography is captured by a sensor which has been fitted with the same type of plenoptic array, the exact location and shape of the photographed object can be more accurately mapped because it is seen on multiple locations on the sensor through the multiple lens tiles, allowing for multiple points of triangulation. Also, the system may make this object mapping even more accurate by showing precise image patterns which are then seen by the sensor from multiple angles.

Based upon the characteristics of the eye, the assistive viewing system can generate a plurality of images. Each of the images can be generated for a portion of the eye. This means that the images can be unique for different portions of the eye and dependent upon the characteristics of the portion of the eye to which the image will be presented. As an example, for a portion of the eye that is affected by macular degeneration, the assistive viewing system can generate an image that includes corrections accounting for the macular degeneration. On the other hand, for a portion of the eye that is not affected by macular degeneration, the assistive viewing system can generate an image with no corrections, or corrections that only address other ocular conditions, in the event that a person suffers from multiple ocular conditions.

These images can then be presented to the eye on a display device. The images are presented in such a manner that it appears to be a cohesive image, even though it is made of multiple images. In other words, the images are presented in a manner that makes it appear to be a single view to the user. Thus, the assistive viewing system can be utilized in a natural environment, much like eyeglasses. As the user is interacting with the world, the user can wear the visual aid device of the assistive viewing system and see the world in a manner more closely to what the person would see if they did not suffer from an ocular condition. In other words, just as eyeglasses or contact lenses can be utilized to account for a person having near sightedness or far sightedness, thereby allowing the person to see the world as if they do not suffer from these ocular conditions, the described system and method can be utilized to account for eye diseases or other ocular conditions.

The system also allows benefits even for users who don't suffer from any health conditions, as well as for some who suffer from health issues not typically seen as affecting vision. It allows a superior method of bringing the coordinated multiple images from the plenoptic display system into precise focus and multiple image tile alignment into a single overall image. This is because it offers a new capability not only to accurately track the position of the pupil (as detailed in a previous cited application and/or patent), it also enables the measurement and tracking of the pupil's position relative to the exact distance from the pupil to each of many particular areas of the retina. Every person's eye is slightly different in shape and size, so that the relative angles from each image tile in the display, through the plenoptic lens, will reach a slightly different area of the retina for each person. The described system and method corrects for that, and also corrects the imagery for focus based on each person's differing measurements from pupil to retina. Furthermore, when the eyeglasses in which the plenoptic system is installed are positioned at different distances and angles to the eye, the described system and method can more accurately adjust the alignment of the multiple tiles images so that they blend together properly and correct most accurately for any distortions associated with lens geometries.

The same synchronized display and image capture system allows for accurate monitoring of blood pressure and other health conditions by being able to detect rapid and minute changes in the shape of blood vessels and nerves. It may also provide visual stimuli and measure reactions to those in rapid and continuously timed sequences (for example, at normal video frame rates such as 60 Hz). Common commercially available OLED, LCD, and microLED displays are capable of illuminating the eye at wavelengths that extend significantly into the near infrared (NIR) range, which can allow objects to be seen by commonly available infrared sensors fairly deep into tissue that is nontransparent to visible light. The system could equally deploy short wave infrared (SWIR) sensors, to see even deeper into tissue. In this manner, the benefits of accurate diagnostics of the eye and nearby brain, tissue and bone regions, such as now achieved with optical coherence tomography (OCT), can be brought to continuous monitoring of a user while the user goes about normal activities.

Referring to FIG. 1, a device 1000, for example, that which is used for the visual aid device or used in conjunction with the assistive viewing system, is described. The device 1000 may include any or all of the following: one or more three-dimensional (3D) cameras 1001 aimed either or both inward at the eye and/or outward to capture the objects viewed by the eye (collectively referred to as 3D camera 1001); outward-facing camera 1002 which captures the scene to be viewed; temporary video storage for each video input 1003; external video source(s) 1004; one or more eye-capture cameras or looking into the eye 1005; memory 1006; microprocessors 1014 (collectively referred to as CPU 1014) and graphics processing units 1015 (collectively referred to as GPU 1015) that retrieve data and/or instructions from memory 1006 and execute retrieved instructions in a conventional manner. Memory 1006 can include any tangible computer readable media, e.g., persistent memory such as magnetic and/or optical disks, ROM, and PROM and volatile memory such as RAM.

CPU 1014 and GPU 1015 and memory 1006 are connected to one another through a conventional interconnect 1006, which may be a bus in this illustrative embodiment and which connects CPU 1014, GPU 1015, and memory 1006 to one or more input devices as mentioned above and/or output devices (collectively referred to as video display 1012). Video display 1012 can include one or more displays-such as an OLED (organic light-emitting diode), a microLED, or liquid crystal display (LCD), and/or the like. Both the image capture device(s) and the output devices may include plenoptic lens arrays. As information is fed from memory 1006 to the video display 1012, it is passed through another logical block for formatting of images for multi-tile presentation on the video display 1013. This formatting is partly informed by analysis of data from the eye capture camera 1010, and also by analysis of data from 3D camera 1011. Information from the camera 1011 is analyzed, which leads to updated software, shown as data analysis and software update 1007. Analysis, reporting, and human input 1008 may inform the computer-generated data analysis 1007.

Information handling device circuitry, as for example outlined in FIG. 1, may be used in devices such as tablets, smart phones, personal computer devices generally, and/or electronic devices, which may be used in a described visual aid device. Thus, the circuitry may be utilized in image capture devices, display devices, processing components, and/or other components of the assistive viewing device. Additionally, it should be noted that the components illustrated in FIG. 1, may not necessarily be co-located within the same component. Rather, different components may be located in different systems or components of the system. The components may then communicate with each other using wired or wireless communication techniques, including, but not limited to, network communication, short-range wireless communication techniques, near-field communication techniques, and/or the like. Communication may also occur across different data storage and/or data processing locations, for example, local networks, remote networks, cloud networks, and/or the like.

With respect to treatment and/or cure of myopia, FIG. 2 illustrates an example of a typical myopic eye showing elongation and different focal lengths for light entering the pupil from different directions. FIG. 3 illustrates an example of projected structured light images using high brightness red light. The problem of myopia is growing exponentially. Theories for why the incidence of myopia is growing rapidly worldwide to include almost all children in most industrialized settings typically explain the phenomenon as due to decreased exposure of youthful eyes to natural light, and increased time spent reading and looking at handheld displays (i.e. focusing the eyes on very close and detailed information rather than the more distant information seen in most of the rest of the viewer's experience). Myopia is also exacerbated by the very therapy typically used to correct it, but this issue points to the solution provided by the described system and method.

The typical pattern of a child repeatedly requiring new, more corrective prescriptions for ever worse myopia is caused by a vicious cycle. Myopia is a matter of the eyeball being elongated in comparison to the focal length of the eye's natural lens. As explained above, the eyeball probably has elongated to accommodate close focusing on reading material, thus defocusing objects farther away, thus “near-sightedness.” To correct the resulting lack of focus, the patient is prescribed a demagnifying corrective lens which lengthens the effective focal length to the central area of focus on the retina. However, the eyeball does not lengthen in a symmetrical sphere to accommodate close focusing, it elongates in a roughly conical fashion. When a corrective lens brings objects into proper focus for the central retina, peripheral areas of the retina get an over-corrected focal length. Therefore, the eye naturally tends to elongate more to bring those areas into the new focal distance. This, in turn, leads to the central area going out of focus again, requiring a stronger prescription (higher negative power demagnification). The vicious cycle can be endless throughout a lifetime, though it certainly is most rapid during earlier years when the body naturally adapts faster.

The described device and method are based upon the device's ability to project separate in-focus images to all areas of the retina which are constructed by the visual cortex into a single full-field stereo image. When peripheral areas of the retina are provided with full-field, in-focus imagery that matches the focus achieved by the fovea, the vicious cycle of elongation the get better ends. Additionally, the described device and method relies on the fact that color does not get combined as comprehensively into that stereo effect as does contrast information. While contrast information, when projected in focus at infinity to a given discreet area of the retina, can be made to fill the entire visual field, color information projected in the same way may be limited to the given section of the visual field unless it is also simultaneously projected in the same manner to multiple other areas of the visual field. In other words, particular color images can be sent or transmitted to particular peripheral areas of the retina and the brain perceives them only in that particular corner of the field of view, even as it creates a full-field image from the contrast information provided by the device.

Research by others has shown that laser-projections of red light to peripheral edges of the field of view can slow down the progress of myopia and even turn it back. Similarly, other research has shown that bright light aimed at the periphery of the field of view has the same effect as red light described above. However, in both cases of using red lasers and extremely bright light, exposure of the eye to these techniques must be limited so as not to cause damage to the eye.

The described visual aid device, however, may be programmed to deliver red light very specifically to appropriate areas of the retina (almost as accurately as any laser), and can also deliver white light with the same pinpoint accuracy and any given desired brightness level. The optics can also deliver fully focused images and textual information in any combination of color values and brightness wherever desired on the retina. While typical structured light patterns may be used, the described device may also create patterns to align with contrasting portions of the overall image seen by the viewer, such that the patterns may be less noticeable in the user's field of view. In addition to assisting with the cure or treatment of myopia, such a technique may also be useful for the treatment of macular degeneration or other ocular conditions.

Additionally, the geometry of the eye can be continually measured by triangulating on structured light patterns. The progress or retreat of myopia, or other ocular diseases or conditions, can thus be tracked in detail for all retinal areas, and particular therapies-amount of red, brightness, etc.—delivered to particular areas of the retina can thus be customized in an automated fashion.

With respect to an application for treatment and/or cure of glaucoma, FIG. 4 illustrates an example for shutting off light to a given ganglion. FIG. 5 illustrates an example image with added points of contrast. As described in the above mentioned patent applications and granted patents, modified stereo images can be presented to a user to treat or account for macular degeneration in the eyes of a user. A similar technique can be utilized to provide treatment for glaucoma. In addition to the contrast information described in the above-mentioned applications and patents, the currently described system includes added brightness and contrast aimed at particular ganglia, while shutting off light to other ganglia.

Similarly, by shutting off light to the very center of the visual field, while maintaining full field sight with plenoptic images shown to the peripheries of the field of view, the device radically reduces glare and fuzziness associated with optic neuritis and allows users afflicted with this condition to see much more clearly.

Also, of great importance for bringing vision to blocked areas of the visual field, is content modification. We have discovered from experimentation that the visual cortex is “programmed” to look for contrast information. Added points of contrasting interest in an otherwise relatively undifferentiated section of the visual field—for example, adding a black dot to an expanse of a single color such as the flesh tone of a person's cheek or the blue of a sky background-actually enables sufferers to see that section of the visual field when otherwise it is not seen. This is different from our previously described tactic of adding contrast, as it adds contrasting information where no color or brightness separation normally would exist in the image for any viewer. Such image manipulation and presentation may also be useful in the treatment of macular degeneration and other ocular conditions.

With respect to treatment, cure, and relief of dyslexia, FIG. 6 illustrates typical areas with no blue photoreceptors in dominant vs. nondominant eyes. FIG. 7 illustrates typical areas without blue photoreceptors for people with dyslexia. FIG. 8 illustrates the changed distribution of blue light in one eye to create eye dominance. Research by others has found that the distribution of blue photo receptors is typically different for those with dyslexia than for those who do not suffer from this. For all, blue photo receptors are distributed away from the central area of the macula, which is typically free of blue photo receptors. In people without dyslexia, the dominant eye exhibits a symmetrical, or roughly circular, absence of blue photo receptors around the fovea, while the nondominant eye exhibits an asymmetrical blue-cone-free area. In people with dyslexia, in contrast, the two eyes exhibit similar blue-cone-free areas. Generally for those with dyslexia, slight differences between the right and left eye are minimal.

The above information is coincident with our finding that blue information, more so than red or green, tends to be localized per lens tile in the described visual aid devices. In other words, while contrast information, and to a much lesser extent, red and green information, generalizes to the full visual field from the retinal areas addressed by one or more discreet images in full focus, blue does not generalize well unless addressed to a large number of the potential retinal areas (e.g. all four corner tiles of a nine tile array).

Eye dominance, like hand dominance, is weakly established at birth, and grows over the early years of life. While some claim that hand dominance can be trained, there appears to be no information on any attempts to establish eye dominance in young people. However, that is exactly what the described system can do. Furthermore, the system can allow easier reading and other detailed observation for those who have dyslexia and are already mature with little or no chance of retraining eye dominance.

Blue photoreceptors are key to this. Blue information is subtracted from images aimed at the fovea and central macula and accentuated to areas in the periphery of the retina for one eye only, resulting in an appropriately blue-tinted image overall, for one eye only. For the other eye, unchanged color information is provided per all image tiles. The choice of which eye to make these changes to would be based on several criteria. Of first importance is handedness. It should be expected that right-handed people are more likely to be comfortable with right eye dominance, and left-handers the opposite. Of secondary importance is the degree of symmetry observed in the pattern of blue eye photoreceptors per each eye, which can be measured utilizing the techniques described in the above-mentioned applications and patents.

Aiding in the differentiation of dominant and nondominant eye, the described visual aid device also may vary frame rate per eye. The eye that is trained for dominance would be given a higher frame rate than the targeted nondominant eye. For example, as a typical microOLED or microLED display is capable of 90 Hz frame rate, the target dominant eye is given 90 frames per second, while the target nondominant eye is given 30 frames per second. Black frames may be inserted in the video feed for the nondominant eye. For example, in the time that the dominant eye sees two frames of video, the nondominant eye may see one frame plus a black frame of equal length. It should be understood, that while the above presentation of different frame rates for each eye may be useful in the treatment, cure, or relief of dyslexia, such frame rate differentiation may also be useful in other applications.

With respect to the induction of hyper visual acuity, FIG. 9 illustrates warped image tiles for use in hyper visual acuity. Visual hyperacuity is best known as the capability possessed by great hitters in baseball, who are legendarily able to see the threads on the ball as it approaches them at high speeds and therefore know whether the pitch will be a curveball or a fastball. This capability has obvious application in many fields from targeting in gunnery to surgery to many other sports and activities. It is actually present to more or less extent and in different circumstances in many people, as it is generally defined as the ability to see an object that is smaller than the optical resolution limit, commonly defined as 1 minute of arc. However, greater degrees of hyperacuity are rare.

Much research over many years has shown that hyperacuity is a functionality of the visual cortex, and not a matter, for example, of certain people being endowed with smaller and more tightly packed photo receptors (as would be the typical way to get more visual acuity in a digital device). Research also shows that hyperacuity is associated with two-eye stereo and with saccadic movement. Furthermore, super-resolution in electronic sensing (which the described visual aid device uses with structured light when mapping the retina) has long been associated with hyperacuity in the human visual system. The key to the described visual aid device providing hyperacuity is its inherent creation of multiple simultaneous stereo views of the same object from different aspects on the retina, inherently allowing the brain to construct super-resolution understanding of what it perceives.

There has also been a great deal of research into both measuring individuals' degree of hyperacuity and in training individuals to make use of greater levels of hyperacuity. In such measurement and training, people are exposed to various graphics with increasingly subtle differences between lines, dots, or other images. Repeated exposure to increasingly tiny offsets in graphics has been proven effective in training the eye for greater hyperacuity. However, these techniques are unable to give a person with average visual acuity the eyesight of, for example, a great baseball hitter.

The software for hyperacuity training in the described visual aid device proceeds similarly but takes advantage of the unique properties of the multiple images it projects to disparate areas of the retina. Each of the images is created on a display with a given pattern of columns and rows of pixels. Each and all of the images must be coordinated with the others that are seen simultaneously such that they present a combined stereo image; that is, each image must be warped such that it accords with the angle of view from that area of the retina onto which it is projected. For example, if the system has an overall square set of image tiles, each behind a separate square lens, then the square-format image aimed at one corner of the field of view projected onto the retina will be warped into a particular barreled-pincushion-parellelogram-keystone-like shape, and the square-format image projected onto the opposite corner of the field of view will have an equal and opposite warped shape. This assumes the geometry of the retina is perfectly spherical, which it is not. Thus, in actual practice the inclusion of retinal mapping by the visual aid device will be utilized to determine the optimal placing of images, and these two image tiles will only be approximately oppositely warped. With the warped two image tiles, the brain will perceive the two images as a square stereo image. The pixel pattern for each of the two images will, however, be perceived as different. The two overlaid pixel patterns will conflict. Additionally, if there is some larger number of image tiles projected onto the retina simultaneously, the device can present an overlay of potentially scores of conflicting pixel patterns in a single stereo image.

These overlaid pixel patterns can be made more or less divergent at the discretion of warping software. Accordingly, as with previously existing hyper visual acuity testing and training in which patterns with progressively subtle differences are shown, the described visual aid device entails showing images with differentially diverging warped pixel pattern overlays.

To the extent that pixel pitch is small enough in the display or displays used in the system, the appearance of pixels will disappear. The commonly understood limit of the eye's ability to perceive any detail is spacing of one minute of arc; any ability to perceive a difference of less than 1 arcmin is defined as hyperacuity. At the typical distance from the eye that the described visual aid device enables, 1 arcmin corresponds to about 1 um spacing between pixels on the display. In general, more resolution is usually better. Most users of the system will appreciate being able to view images from displays with resolution so fine that they do not see pixels at all. However, stereo perception of multiple simultaneous images with differently warped pixel structures both reinforces the brain's sense of focus (just as a person with myopia in both eyes will see a distant image in somewhat better focus—or less bad focus—using both eyes than with only one eye), and also smudges the “screen door” pattern of pixels by presenting multiple overlaid and differing patterns. Accordingly, for many users of the system, the appearance of a pixel pattern and seemingly perfect resolution will be achieved with significantly lower screen resolution than 1 um pitch.

These phenomena can also be used to train and induce hyperacuity. Even when using optimal displays with a pitch of 1 um or less, given areas of the image on some number of the image tiles can be coded for blockier pixels: sections of two, three, four, or more pixels treated as a single pixel. This section of the overall image may appear as a diagonal in one of the coordinate stereo views and as a slightly different diagonal in another, and so forth. Alternatively, more detail may be provided in such a superpixel in one view and not in another. The number of possibilities for adjusting images to show very tiny differences in the multiple simultaneous stereo views, as well as in changing imagery at a given frame rate approaches infinity.

Besides the previously understood ability to train for hyperacuity with increasingly subtle differences, the system adds the ability to make use of what independent research has established as at least coincidence, if not a causal relationship, between hyperacuity and stereopsis. Divergent tiny details of information presented simultaneously, from image tile to image tile across the extent of the retina, is expected to do an exponentially better job at training for hyperacuity than the sequential viewing of patterns seen in a normal way.

Techniques similar to those that have been previously discussed in connection with FIG. 1-FIG. 9 can be utilized to increase the visual field of those that suffer from a reduced visual field or limited sight. For example, those users who suffer from a stroke may have a reduced visual field or limited sight from the stroke. Users who suffer from stroke may have resulting limited sight due to changes in the brain caused by the stroke. In other words, the limited sight from the stroke, or other condition, is not a change in the eye, but is rather a change in the brain that causes the brain to no longer process the entirety of the visual field that may be “seen” by the eye. The described system can provide a stereo effect that assists in increasing the visual field of those who suffer from limited sight.

Users' gaze will be tracked, both to allow the user to gaze to a “yes” or “no” choice on screen to tell the system whether or not they see the details, and to measure saccadic movement as the user observes these details to note the difference between when the user does and does not perceive desired details. Upon the user's attainment of what the system judges to be a given level of hyperacuity, more complex graphics would be substituted, with the training repeated. These steps can be repeated with a gradually decreasing scale of differences, to allow users to attain their maximum level of hyperacuity. The software will also be able to score participants and report scores, both for the purpose of improving the teaching algorithm and to allow managers to choose users with the highest scores for particular tasks.

Accordingly, the described method may be a method that generates images to account for an ocular condition or vision problem of a person utilizing the assistive viewing system or visual aid device, and may not only be used to counter the effects of macular degeneration, glaucoma, myopia, dyslexia, and induce hyperacuity, but also of other vision and ocular conditions, for example, retinitis pigmentosa, retinopathy of various kinds, glaucoma, cone-rod dystrophy, optic neuritis, reduced visual fields or limited sight due to stroke, and others. Slightly different techniques may be used for each of these different conditions. In all these cases, the exact required image displacement or image modification may be obtained either by the cameras focused internally into the eye and also by test patterns which allow the user, or a physician or other human operator, or software deployed in the system, to conform the images based upon the desired application. This method may be implemented on a system which includes a processor, memory device, the near-eye display, as well as output devices other than the near-eye display (e.g., other display devices, printer, etc.), input devices (e.g., keyboard, touch screen, mouse, microphones, sensors, biometric scanners, etc.), image capture devices, and/or other components, for example, those discussed in connection with FIG. 1. While the system may include known hardware and software components and/or hardware and software components developed in the future, the system itself is specifically programmed to perform the functions as described herein. Additionally, the visual aid device includes modules and features that are unique to the described system.

The visual aid device may be implemented on a single information handling device or a system of devices. Generally, the user may wear a device, referred to as the visual aid device. These may be in the form of smart eyeglasses or smart contact lenses, a head-mounted display, an augmented or virtual reality display, and/or the like. The visual aid device may include certain components that are needed near the field of vision of the user, for example, image capture devices, display devices, and/or the like. However, in the interest of processing power, weight of the visual aid device, heat produced by the device, and other considerations, other components may be located in a separate location different from the visual aid device. For example, some processing and or data storage may be conducted or located in a cloud storage or network location, remote network location, local network location, and/or the like. The visual aid device may therefore also include communication components allowing for communication to the other components. These components, including the visual aid device, components located on the visual aid device, and separately located components all work together to make up the assistive viewing system. Thus, the use of the term information handling device, visual aid device, and/or assistive viewing system may refer to a single device or a system of devices.

An artificial intelligence model, which may be a neural network, decision tree and/or forest, classifiers, random tree forest or classifier, a combination thereof, a combination of artificial intelligence models, and/or the like, may be utilized in performing one or more acts of the assistive viewing system. For example, one or more artificial intelligence models can be used to identify ocular conditions, identify corrections that need to be made to result in a more natural viewing field for a user, identify images of the eye that need to be obtained, and/or the like. It should be understood that while the terminology may refer to a single artificial intelligence model, multiple artificial intelligence models can be utilized in performing one or more functions of the scheduling system. The artificial intelligence model may include a plurality of layers, including input, output, hidden, a combination thereof, and/or the like, layers. The artificial intelligence model is very complex and utilizes complicated mathematical computations. Given the highly precise image adjustments taught herein, it should be appreciated that inaccuracies may be expected, but that the system must measure the user's response to these inaccurate corrections, both conscious and unconscious (such as pupil dilation, rapid pupil movement in a direction that may be associated with unconscious attempts to adjust the correction, etc.) and to adjust image compensation accordingly in a self-learning and self-adjustment manner. Due to the complexity of the artificial intelligence model, it would be impossible to perform the analyses as performed by the model in the human mind.

Additionally, the artificial intelligence model is trained to or utilized to make predictions on data that has been previously unseen by the model. To make these predictions, the model includes very complicated mathematical computations that would not be performed in the human mind. Rather, the use of a computer and processor, and, possibly a computer and processor that is specific and tuned to the artificial intelligence model, allows for performing these complex computations, particularly with a speed that allows for performing the complex processing found in and required by the artificial intelligence model in a time frame that facilitates the use of the artificial intelligence model for making the predictions. This speed is not possible with a human or even a group of humans. Thus, a human or even a group of humans, even using pen and paper, could not perform the analyses performed by the artificial intelligence model in a manner that would actually result in making the predictions provided by the artificial intelligence model on the large amount of data that is received by the assistive viewing system in a length of time that would make the assistive viewing system function as intended.

The artificial intelligence model may be trained using a training dataset having annotated training data. Annotated training data includes data that the model may make a prediction upon where the data is annotated with the correct prediction. The artificial intelligence model can learn from the training dataset how data should be classified or the predictions that should be made with respect to particular data. As predictions are made upon non-annotated data, feedback may be provided. Feedback may be provided in the form of a user making a correction, a user providing input regarding the prediction, predictions from other models regarding the same data, and/or the like. The feedback can be automatically ingested by the model to further train the model, thereby making the model more accurate over time. It should be noted that the model can monitor the predictions made by the model to identify the feedback so that a user does not have manually provide the feedback to the model. Thus, while the model may initially be trained with a training dataset, the model can continually be trained as it is deployed using predictions and feedback regarding the predictions. In the case of the ocular conditions and identification of field of view corrections based upon the ocular conditions, the artificial intelligence model may be trained using ocular condition data and may, therefore, be able to identify associated field of view corrections. Similar training and corresponding predications may be used for other portions of the described system. The artificial intelligence model also be trained using unsupervised learning techniques, other supervised learning techniques, reinforcement training, a combination thereof, and/or the like.

While the disclosure will refer to an eye of a user, it should be readily understood that the visual aid device will generally cover both eyes of the user, where applicable. Thus, the same method can be used for the other eye of the user. It should be noted that the eyes of the user may suffer from different vision problems or ocular conditions and/or different degrees of a vision problem or ocular condition. Thus, different images may be presented to each eye to account for the vision issues of each eye and even different vision or ocular conditions and/or degrees of those conditions for different portions of an eye.

Additionally, since the visual aid device or system utilizes computer technology, the system can generate and present images very quickly. This allows the system to frequently, continually, or otherwise generate and present images to account for the user's vision conditions. In other words, as input regarding the vision condition is received at the system, the system can adjust the images that are presented in near-real time. Thus, the visual aid device provides a technique that allows for changes to be made throughout the day, thereby providing a visual aid device that can optimize a viewing experience for the user as vision conditions change. For example, as a user becomes tired, vision conditions may appear to worsen and the system may account for this apparent deterioration in the vision conditions. On the other hand, when the user is refreshed, vision conditions may appear to be better, so the system may account for this apparent restoration of the vision conditions.

The system can continually or frequently capture images of the eye. The frequency at which images are captured can be a default frequency, set by a physician or system administrator or even a user, based upon receipt of a trigger event (e.g., movement of the eye; changing of environmental conditions such as light, humidity, barometric pressure, elevation changes, and/or the like; etc.), based upon receipt of an input by the user indicating an image should be obtained (e.g., pressing a button, providing a gesture, providing a word or phrase, etc.), and/or the like. Thus, the assistive viewing system may include components that can measure different environmental conditions (e.g., humidity sensors, pressure sensors, light sensors, etc.), receive user inputs (e.g., buttons, gesture detection, microphones, etc.), biometric sensors, and/or the like.

The visual aid device can identify a plurality of characteristics of the eye from the image(s). The characteristics may include identifying a position of the pupil with respect to the entire eye. The characteristics may include a geometry of the eye, as identified from the obtained images. In addition to identifying an accurate position of the pupil relative to the unique geometry of a user's eye, the system can also identify the position of phenomena across the eye, which may be indicative of a trait associated with at least one disease. Thus, the phenomenon may be a characteristic. In some vision conditions or diseases, phenomena are found in the eye. For example, in the example of macular degeneration, fatty deposits, leaky blood vessels, and/or the like, may be present in or across the eye or portions of the eye. The system can not only identify these phenomena, referred to as characteristics, but can identify the specific location of these phenomena across the eye. Macular degeneration, for example, may present in various discontinuous or partly continuous areas of the eye while leaving other areas with relatively good vision. Glaucoma, as another example, may have similar effects but with different causation, or may reduce the field of view of the user in different ways. Thus, the system can identify which portions of the eye are affected by a particular vision condition.

Similarly, the system can identify characteristics that are indicative of ocular or vision conditions other than eye diseases, for example, visual acuity characteristics which may be indicative of near-sightedness, far-sightedness, astigmatism, and/or the like. For example, the distance from fovea to pupil is determinant of near-sightedness or far-sightedness. This distance may be measured precisely by the described system and method. As another example, pupil dilation, pupil location, blood vessel engorgement, and many other characteristics, may change when the user sees an object in focus as opposed to when the user sees certain objects in different areas of the field of view, under different lighting conditions, and/or the like. Critically, the system can measure visual acuity and perception of contrast and color for each of multiple areas of the retina, not merely for the full visual system combined (and thus largely, in normal practice, measuring foveal acuity). Thus, the system can identify not only the characteristics of the eye that are indicative of visual acuity, but also that are indicative of many other health conditions.

Since the assistive viewing system is capable of continual real-time monitoring of the full inner geography of the eye, the assistive viewing system can be used to monitor other characteristics of the eye, for example, blood pressure readings and other attributes that may be indicative of health problems, for example, diabetic retinopathy, angiography, and/or the like. Additionally, the localized flash photography and wide range of color gamut allows for identifying fluorescence characteristics of the eye and in particular areas of the eye which may aid in health monitoring. Thus, the characteristics identified may include any characteristics that may aid in detecting ocular conditions, health conditions, and/or the like.

The system may generate images to be presented to the eye(s) based upon the identified application. In generating images, for some applications, the assistive viewing system may map details of the eye from the at least one image. This mapping may result in a virtual or digital reconstruction of the eye including all characteristics of the eye, including the phenomena. Based upon this virtual or digital reconstruction, the system can determine if images can be generated that would account for or address the characteristics of the eye. For example, the system may compare the virtual or digital reconstruction of the eye or portions of the reconstructed eye to a database that may include sets of characteristics and images or image attributes that can be applied to assist in compensating for the characteristics. The database may also identify how much the image attribute should be modified to account for the degree of the characteristic.

The visual aid device may also, or alternatively, use a rules engine. With a rules engine, the characteristic is fed to the rules engine and the rules engine analyzes the characteristic(s) against rules generated by or contained within the rules engine. The rules engine then outputs a set of image attributes that should be applied to compensate for the characteristic. As another example, the system may utilize the artificial intelligence model(s), as described further herein, to determine if images can be generated to account for the characteristics. The artificial intelligence model(s) may be deployed to analyze the characteristics, including the mapping of the eye, to identify if images could be generated that would account for the characteristics.

It should be noted that the analysis performed in determining if an image or set of images can be generated is fairly complicated because not only is the system determining an output for a single characteristic, but the system can also take into account a plurality of characteristics that can be present at the same time and that can affect the same image attribute and different image attributes at the same time. Additionally, since the system generates at least one image for each of a plurality of portions of the eye at the same time, the analysis becomes more complex because the same analysis is performed across multiple portions of the eye for images that will be all presented at the same time to provide a cohesive image, thereby providing for a corrected viewing field for the user.

Generating and presenting the images may also include updating the currently presented images. Generating the images may include generating an image for each portion of the eye. As previously discussed, ocular conditions may only affect a portion of the eye. Accordingly, instead of generating a single direct full image to the entire eye, as found in conventional surgical techniques, the assistive viewing system can generate an image for each portion of the eye.

Generating the image may include applying the rules, database attributes, artificial intelligence model(s) predictions, and/or the like, to the image for a given portion of the eye. In other words, the system identifies the characteristic(s) for a portion of the eye, determines what image attributes should be applied to account for the characteristics with respect to the portion of the eye, and then generates the image having the identified image attributes for the portion of the eye. Thus, generating the images is performed in view of the characteristics, which may include the mapping of the details of the eye. Once the image(s) are created, the system presents the plurality of images to the eye. Each of the plurality of images is presented to the portion of the eye that corresponds to the image that is generated. In other words, the image that was generated for a particular portion of the eye is presented to that portion of the eye. This may be accomplished by presenting the images to the portion of the eye based upon the mapping of the eye.

Since multiple images are created, the visual aid device can join the images into a single overall image, thereby generating a single large field of view within good perceived clarity. To generate the single overall image, the system may warp displayed images to allow them to appear in more accurate focus and/or alignment into the overall image as perceived given the mapped geometry of the eye. The assistive viewing system may deliver multiple overlapping but slightly different images that conjoin into a single overall image, utilizing multiple discontinuous areas of the eye, and fuse the overall set of images created on the eye into a single large field of view with good perceived clarity.

To present the images to the eye, the system may utilize one or more display devices that are aimed at the eye and that are able to deliver properly focused images to any specific area of the eye as desired. The display devices may utilize a plenoptic lens array. The display can pass well-focused images through the pupil without engaging the pupil's focusing muscle and then present those images to any number of specific small sections of the eye, for example, small sections of the retina.

Thus, the assistive viewing system can detect a vision condition and then correct for, provide relief for, or assist in the treatment or cure of the ocular condition. Additionally, the device is able to be used in training hyperacuity in a user. Multiple vision conditions and corrections may occur at a single time, thereby providing correction for multiple vision conditions for the user with a single visual aid device. Additionally, it should be noted that the vision conditions may be detected using different steps or methods as compared to the following examples. It should also be noted that some of the described examples may be further description of those devices and methods previously described.

Although the Stanhope-plenoptic lens array typically delivers images in focus to most users, no matter their visual acuity, the system (or some outside diagnostics) may determine that a given users' required focus correction is unusually outside the bounds of typical in-focus viewing, in such a case, an additional focusing lens element may be added in front of the plenoptic lens array, or either behind or in front of each of the separate lens tiles in the array, or, as suggested in the associated U.S. applications and patents mentioned herein, the plenoptic lens array may be formed by prism or other structures within a liquid crystal cell, or by a metalens, and the focal length of such lenses may be adjusted to conform to the required correction. The lens arrays may also allow for adjustment of different characteristics of the lens array. For example, the system may allow for changing the angle of deflection of each of the lenses within the lens array; or, similarly, a portion of one or more of the images in the array may be warped with software such that it seems to come from a different angle of deflection. In other words, the system can change, on a pixel-by-pixel basis, an angle of deflection. This may be useful in assisting in correcting different vision conditions.

It should be noted that the vision correction techniques described herein work because the brain interprets multiple in-focus and discreet images projected to disparate areas of the retina or eye. The brain naturally constructs a combined stereo image out of these multiple images, if they are shown to multiple different areas of the retina in focus and coordinated for perspective such that they are similar enough to each other in content so that the brain does not reject one or more of the images as noise or interference. If they are not similar enough to each other so that the brain rejects one or more of the images, but rather each presents a complementary point of view of the same content, such that the angle at which the content is seen by each region of the retina shows a complementary stereo image in relation to each other area, then the brain interprets the overall scene as one single scene. This is similar to how the brain processes stereo imagery seen normally with two eyes by those with normal healthy vision.

This phenomenon allows stereo images to be constructed in other ways than using a single display device that presents multiple images. For example, multiple display devices can be utilized to create a set of images that the brain interprets as a single image. As an example, the display device may include any of the lens arrays previously discussed. Each of the display devices may then be located directly in back of a single Stanhope lens. However, other configurations are contemplated and possible. The set of displays can show coordinated views of a single scene to multiple areas of the retina from multiple positions within the field of view of each eye. In other words, each of the displays may display an image that is a different image as compared to images displayed by the other display devices within the set. For example, each display device within the display device set may display a different view of a scene.

As an example system, the set of display devices may be located around the perimeter of the field of view of a user, such as within rims of eyeglasses, a head mounted display, an augmented reality headset, and/or the like. It should be noted that the shape of the set of displays may be any actual shape, for example, a rectangle, circle, oval, parallelogram, triangle, and/or the like. Thus, the set of displays can be coordinated in any shape to match the application, for example, to match the shape of the rims of the eyeglasses. Also, as previously noted, the image projector may be any type of lens array, for example, laser scan display, metalens, or any other optical technique that can be used to project a parallel ray image to the retina in full focus at infinity without engaging the focusing mechanism of the pupil. The central area of the field of view for each eye may then be left empty of displays or may be used for other displays, that were previously discussed, to correct for other vision conditions, or a telescope, or other displays or lens that are usable for the application.

In this arrangement, each Stanhope lens, or other lens in the array, may be aimed at the pupil and may project its image as a parallel ray through the pupil to appear in focus on a given area of the retina. If the lenses are located in series in the periphery of the field of view, the multiple images will appear on the retina also in series around its periphery. Depending on the lens array and/or display device/projector utilized, the images will appear on the opposite side of the retina as compared to the location or position of the projector with respect to the eye. If the relative perspectives of the same basic scene shown by each display device or projector are properly coordinated, as discussed in detail previously, the viewer will perceive a single overall scene, filling most of the viewer's field of view including the central area where there may be no image projected. This occurs regardless of the condition of the eye of the user. In other words, this will occur for those viewers suffering from macular degeneration and will also occur for those viewers who have normal vision.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. Additionally, the term “non-transitory” includes all media except signal media.

Program code embodied on a storage medium may be transmitted using any appropriate medium, including but not limited to wireless, wireline, optical fiber cable, radio frequency, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, the method comprising:
identifying a location of interest on an eye of a user;
identifying an application of a visual aid device being worn by the user;
generating a plurality of images based upon the application; and
presenting, on the visual aid device, the plurality of images at the location of interest.

2. The method of claim 1, wherein the application is curing myopia of the user and wherein the plurality of images comprise a predetermined color at a predetermined brightness.

3. The method of claim 1, wherein the application is correcting a visual field in view of glaucoma of the user and wherein the plurality of images comprises images having differing brightness and contrast values as compared to other of the plurality of images and wherein each of the plurality of images is presented at a different location of interest on the eye of the user.

4. The method of claim 1, wherein the application is relieving dyslexia of the user and wherein the plurality of images comprises images having different color values as compared to other images and wherein the presenting comprises presenting different images to each eye of the user.

5. The method of claim 1, wherein the application is inducing hyper visual acuity in the user and wherein the plurality of images comprises successive images having different patterns.

6. The method of claim 1, wherein the identifying of the location of interest comprises identifying different phenomena across the eye.

7. The method of claim 1, wherein the identifying of the location of interest comprises capturing at least one image of at least one portion of the eye via illumination of the at least one portion of the eye.

8. The method of claim 1, wherein the generating of the plurality of images comprises generating different images for different portions of the eye.

9. The method of claim 8, wherein the presenting of the images comprises presenting the different images as a cohesive image.

10. The method of claim 1, wherein the identifying of the application comprises identifying a condition of the eye of the user and identifying a treatment of the condition.

11. A system, the system comprising:
a processor;
a memory device that stores instructions that, when executed by the processor, causes the system to:
identify a location of interest on an eye of a user;
identify an application of a visual aid device being worn by the user;
generate a plurality of images based upon the application; and
present, on the visual aid device, the plurality of images at the location of interest.

12. The system of claim 11, wherein the application is curing myopia of the user and wherein the plurality of images comprise a predetermined color at a predetermined brightness.

13. The system of claim 11, wherein the application is correcting a visual field in view of glaucoma of the user and wherein the plurality of images comprises images having differing brightness and contrast values as compared to other of the plurality of images and wherein each of the plurality of images is presented at a different location of interest on the eye of the user.

14. The system of claim 11, wherein the application is relieving dyslexia of the user and wherein the plurality of images comprises images having different color values as compared to other images and wherein the presenting comprises presenting different images to each eye of the user.

15. The system of claim 11, wherein the application is inducing hyper visual acuity in the user and wherein the plurality of images comprises successive images having different patterns.

16. The system of claim 11, wherein the identifying of the location of interest comprises identifying different phenomena across the eye.

17. The system of claim 11, wherein the identifying of the location of interest comprises capturing at least one image of at least one portion of the eye via illumination of the at least one portion of the eye.

18. The system of claim 11, wherein the generating of the plurality of images comprises generating different images for different portions of the eye.

19. The system of claim 18, wherein the presenting of the images comprises presenting the different images as a cohesive image.

20. A product, the product comprising:
a computer-readable storage device that stores executable code that, when executed by a processor, causes the product to:
identify a location of interest on an eye of a user,
identify an application of a visual aid device being worn by the user,
generate a plurality of images based upon the application; and
present, on the visual aid device, the plurality of images at the location of interest.
